(19) United States
(12) Patent Application Publication
(10) Pub. No.: US 2011/0216781 A1
(43) Pub. Date: Sep. 8, 2011

(54) Method and Apparatus for Asynchronous Orthogonal Frequency Division Multiple Access

(75) Inventor: David BARR, San Jose, CA (US)

(73) Assignee: ENTROPIC COMMUNICATIONS, INC., San Diego, CA (US)

(21) Appl. No.: 13/075,719

(22) Filed: Mar. 30, 2011

Related U.S. Application Data
(63) Continuation-in-part of application No. 13/041,662, filed on Mar. 7, 2011.
(60) Provisional application No. 61/310,813, filed on Mar. 5, 2010.
(60) Provisional application No. 61/320,490, filed on Apr. 2, 2010.
(60) Provisional application No. 61/328,061, filed on Apr. 26, 2010.
(60) Provisional application No. 61/371,284, filed on Aug. 6, 2010.

(51) Int. Cl. H04J 4/00

(52) U.S. Cl. 370/436; 370/478

(57) ABSTRACT

A method of transmitting orthogonal frequency division multiple access (OFDMA) signals includes transmitting, at a first transmitter of a network, a first stream of data having a first number of symbols over a first time interval using a first set of one or more OFDMA subcarriers. At a second transmitter of the network, a second stream of data is transmitted having a second number of symbols over a second time interval, different in duration than the first time interval and overlapping the first time interval. The second burst of data is transmitted using a second set of one or more OFDMA subcarriers. The first time interval and first set of subcarriers define a first time-frequency grant, the second time interval and second set of subcarriers define a second time-frequency grant, and the first and second time-frequency grants are granted by a network coordinator node of the network.

### CROSS-REFERENCE TO RELATED APPLICATIONS

This application is a continuation-in-part of Application Ser. No. 13/041,662, filed Mar. 7, 2011, which claims priority under 35 U.S.C. §119(e) from the following provisional applications: Provisional Application Ser. No. 61/310,813 filed Mar. 5, 2010, the entirety of which is hereby incorporated by reference herein; Provisional Application Ser. No. 61/320,490, filed Apr. 2, 2010, the entirety of which is hereby incorporated by reference herein; Provisional Application Ser. No. 61/328,061, filed Apr. 26, 2010, the entirety of which is hereby incorporated by reference herein; and Provisional Application Ser. No. 61/371,284, filed Aug. 6, 2010, the entirety of which is hereby incorporated by reference herein.

### FIELD

This disclosure is directed generally to communication systems. More particularly, some embodiments relate to a method and apparatus for asynchronous communication in an Orthogonal Frequency Division Multiple Access system.

### BACKGROUND

Orthogonal Frequency Division Multiple Access (OFDMA) systems are prevalent today. Typically, in an OFDMA system, the signals of several different users (i.e., entities that wish to communicate over the communication system) will each be assigned one or more unique subcarriers. Each subcarrier is generated and transmitted in a manner that allows all of the subcarriers to be transmitted concurrently without interfering with one another. Therefore, independent information streams can be modulated onto each subcarrier whereby each such subcarrier can carry independent information from a transmitter to one or more receivers.

In one current OFDMA system described in the Multimedia over Coax Alliance (MoCA) industry standard, MoCA 2.0 network coordinators (NCs) (sometimes referred to as network controllers) coordinate synchronous OFDMA transmissions for upstream reservation requests. That is, each participating/requesting network node is scheduled to simultaneously transmit a preamble of a respective message, followed by a payload of the corresponding message that is transmitted simultaneously. Each node transmits on its own set of subcarriers, with a set of subcarriers defining a logical subchannel.

MoCA may be implemented in the context of a hybrid fiber-coaxial (HFC) broadband network 150 shown in FIG. 1B. HFC network 150 includes a fiber optic network 151 and a coaxial network 152. The fiber optic network 151 includes a transport ring 153, including a head-end node 154, one or more distribution hubs 156 (shown as hubs 156a and 156b in this example), and a cable modem termination system (CMTS) 158 for connection to one or more fiber optic nodes 160 (shown as fiber optic nodes 160a and 160b in this example; sometimes referred to as optical nodes) that provide an interface between the fiber portion 151 and coaxial portion 152 of the network 150. Each optical node 160 includes a receiver 161 and a transmitter 162 that provide communications in downstream and upstream directions, respectively, as denoted by arrows 163 and 164. The downstream direction typically corresponds to point-to-multipoint (i.e., broadcast) communications, and the upstream direction typically corresponds to multipoint-to-point communications. Receiver 162a converts the downstream-directed optically modulated signal originating from the transport ring 153 to an electrical signal for distribution to customers 180 (e.g., homes 180) in a network 170, which may be a residential network. A trunk RF amplifier 172 and one or more line RF amplifiers 174 may be used to increase signal strength. Transmitter 161a provides upstream communications from customers 180 to the head-end 154 on a return path.

Referring to FIG. 1B, in a known OFDMA transmission technique, time-frequency slots that are two-dimensional intervals in time-frequency space are granted to transmitters T1 and T2, respectively, which may correspond to respective nodes of residential network 170. T1 is granted a first set of one or more logical subchannels 110a, and T2 is granted a second set of one or more logical subchannels 110b, with T1 granted more bandwidth in this example. Time intervals are granted on the basis of fixed time duration, which may correspond to a given number of symbols (e.g., 20 symbols). Two time intervals 120a and 120b of equal duration are shown in this example. The transmission schedule is synchronous in this example, and the time-frequency slots conform to a periodic grid.

Each data stream (e.g., packet) that is sent starts transmission at the same time so that the preambles of packets sent by respective transmitters are aligned in time. In this example, packets 132 and 142 are sent at the same time (i.e., at the start of time interval 120a) so that their respective preambles 133 and 143 are aligned in time. However, packets may have different lengths, e.g., due to differing lengths of respective payloads 134 and 144. Therefore, if a shorter packet (e.g., packet 132) is sent on one set of subchannels (e.g., subchannels 110a), and a longer packet (e.g., packet 142) is sent on another set of subchannels (e.g., subchannels 110b), the subchannels on which the shorter packet was sent will be padded or idle, waiting for the completion of the transmission of the longer packet, as shown by idle interval 122. Additional packets may be sent in the next time interval 120b.

In particular, in a network where all upstream traffic is destined for a network coordinator (NC), the beginning and end of various packet transmissions may not align precisely. This misalignment may be due by different nodes transmitting packets of various lengths (e.g., from 64 to 1518 bytes each). Alternatively, this misalignment may be due to different nodes transmitting over separate subchannels with differing bit loadings and subchannel widths. For example, a first node may be required to transmit its packets over subchannels corresponding to narrower bandwidth than a second node. The first node may use a lower-order bit loading than the second node in order to improve the fidelity of the transmission. Since the system is constrained to synchronous OFDMA, a node with a short packet (destined for the NC) might have to wait for another node to finish transmitting a long packet (also destined for the NC) before the two nodes could synchronously transmit respective their preambles and new payloads, limiting flexibility and efficiency.

### SUMMARY

In some embodiments, a method of transmitting orthogonal frequency division multiple access signals includes transmitting, at a first transmitter of a network, a first stream of data having a first number of symbols over a first time interval using a first set of one or more Orthogonal Frequency Division Multiple Access (OFDMA) subcarriers. At a second transmitter of the network, a second stream of data is transmitted having a second number of symbols over a second time interval, different in duration than the first time interval and overlapping the first time interval. The second burst of data is transmitted using a second set of one or more OFDMA subcarriers. The first time interval and first set of subcarriers define a first time-frequency grant, the second time interval and second set of subcarriers define a second time-frequency grant, and the first and second time-frequency grants are granted by a network coordinator node of the network.

In some embodiments, a method of transmitting orthogonal frequency division multiple access signals includes transmitting, at a first transmitter of a network, a first stream of data over a first time interval using a first set of one or more Orthogonal Frequency Division Multiple Access subcarriers. At a second transmitter of the network, a second stream of data is transmitted over a second time interval using a second set of one or more OFDMA subcarriers. The first time interval and first set of subcarriers define a first time-frequency grant, the second time interval and second set of subcarriers define a second time-frequency grant, and the first and second time-frequency grants are granted by a network coordinator node of the network.

In some embodiments, a method of scheduling transmission of orthogonal frequency division multiple access signals is performed at a network coordinator node of a network. The method includes allocating a first time-frequency grant to a first network node of the network. The first time-frequency grant corresponds to a first time interval and a first set of one or more orthogonal frequency division multiple access subcarriers. A second time-frequency grant is allocated to a second network node of the network. The second time-frequency grant corresponds to a second time interval, different in duration than the first time interval and overlapping the first time interval, and to a second set of one or more OFDMA subcarriers. A first message is transmitted to the first network node specifying the first time-frequency grant, and a second message is transmitted to the second network node specifying the second time-frequency grant.

In some embodiments, a method of scheduling transmission of orthogonal frequency division multiple access signals is performed at a network coordinator node of a network. The method includes allocating a first time-frequency grant to a first network node of the network. The first time-frequency grant corresponds to a first time interval and a first set of one or more orthogonal frequency division multiple access subcarriers. A second time-frequency grant is allocated to a second network node of the network. The second time-frequency grant corresponds to a second time interval, bordering the first time interval, and to a second set of one or more OFDMA subcarriers. The second set includes at least one subcarrier in the first set and at least one subcarrier not in the first set. A first message is transmitted to the first network node specifying the first time-frequency grant, and a second message is transmitted to the second network node specifying the second time-frequency grant.

In some embodiments, an apparatus (which may include a microchip) includes a processor, a computer readable storage medium, a buffer, a transmitter, a receiver, a timer, and a bus that is configured to provide communication between other apparatus components. Within a chip corresponding to a network node on a network, the processor functions to implement the transmission schedule for that node. Instructions stored tangibly on the storage medium may cause the processor 410 to effectuate transmission in accordance with the methods of transmitting orthogonal frequency division multiple access signals described above. Schedule orders received from a network coordinator (NC) via the receiver may be stored in the buffer. Based on the timer and the schedule received from the NC, the processor may cause the transmitter to initiate a data burst (transmit a stream of data).

In some embodiments, an apparatus (which may include a microchip) forming a network coordinator (NC) node on a network includes a processor, a computer readable storage medium, a transmitter, a receiver, a timer, and a bus that is configured to provide communication between other apparatus components. Within a chip corresponding to the NC, the processor functions to determine a time-frequency grant schedule for various recipient nodes and transmit the schedule to the recipient nodes. Instructions stored tangibly on the storage medium may cause the processor 410 to effectuate transmission of messages indicating the grants in accordance with the methods of scheduling transmission of orthogonal frequency division multiple access signals described above. The NC node is configured to coordinate asynchronous transmissions for upstream reservation requests of the first and second recipient network nodes received at the receiver.

### BRIEF DESCRIPTION OF THE DRAWINGS

The following will be apparent from elements of the figures, which are provided for illustrative purposes and are not necessarily to scale.

FIG. 1A is a network diagram of a known hybrid fiber/coaxial (HFC) broadband network topology.

FIG. 1B is an illustration of a known Orthogonal Frequency Division Multiple Access transmission technique.

FIG. 2 is a block diagram of a communication system.

FIG. 3 is a block diagram of a network node in accordance with the communication system illustrated in FIG. 2.

FIG. 4 is a block diagram of a hardware chip-level implementation of a network node in accordance with the communication system illustrated in FIG. 2.

FIGS. 5A-B are illustrations of OFDMA transmission in accordance with some embodiments.

FIG. 6 is a flow diagram in accordance with some embodiments.

FIG. 7 is a flow diagram in accordance with some embodiments.

FIG. 8 is a flow diagram in accordance with some embodiments.

FIG. 9 is a flow diagram in accordance with some embodiments.

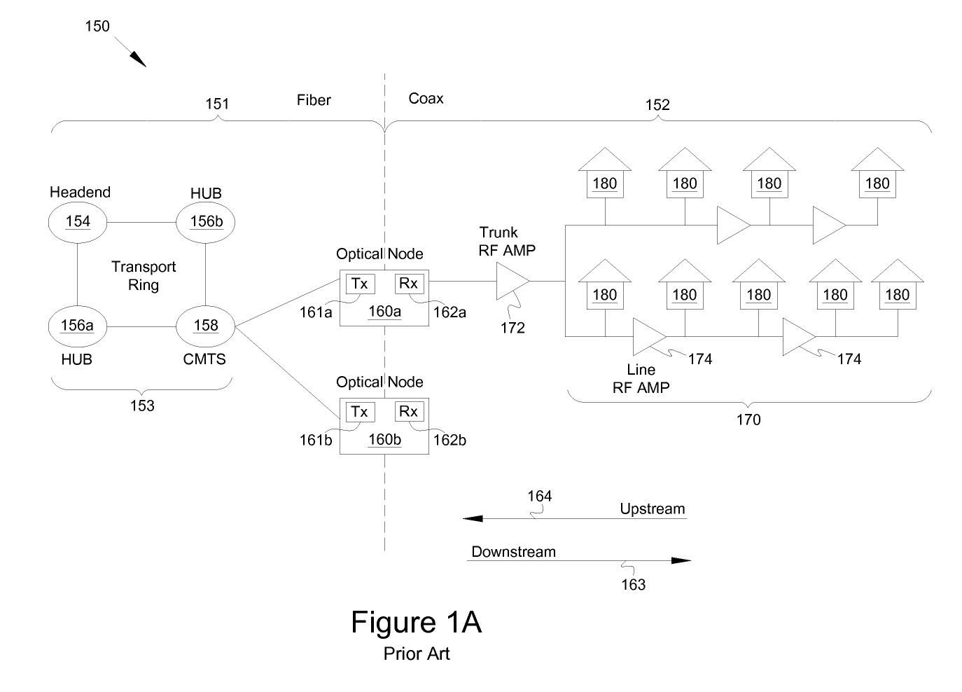

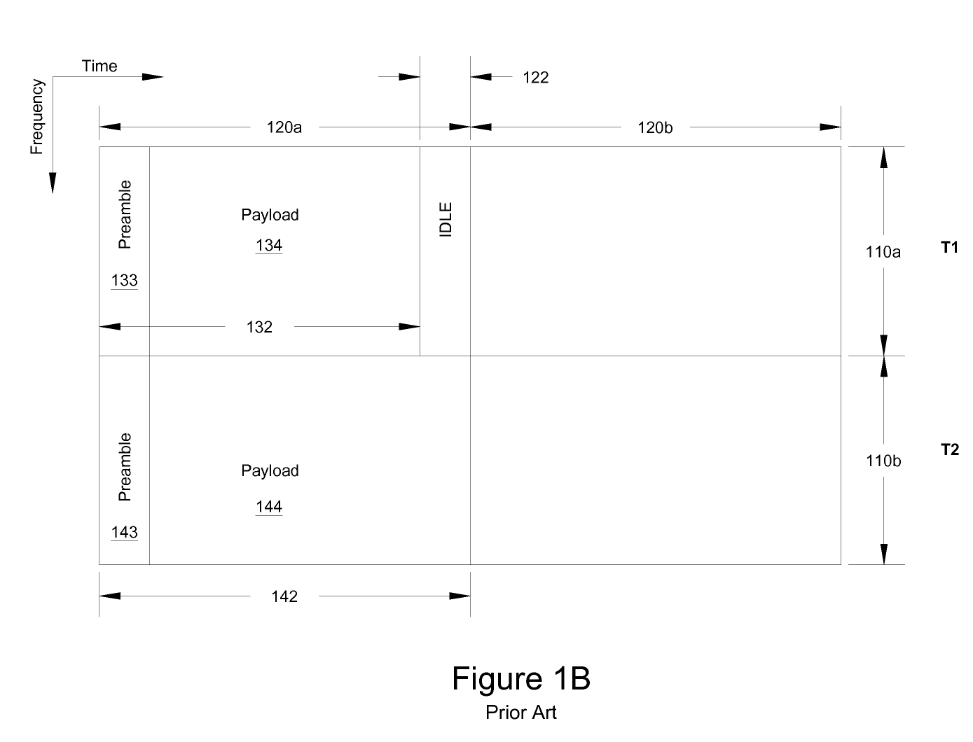

### DETAILED DESCRIPTION

This description of the exemplary embodiments is intended to be read in connection with the accompanying drawings, which are to be considered part of the entire written description.

Various embodiments of the present disclosure provide additional flexibility and efficiency relative to known synchronous OFDMA techniques by providing asynchronous OFDMA communication functionality.

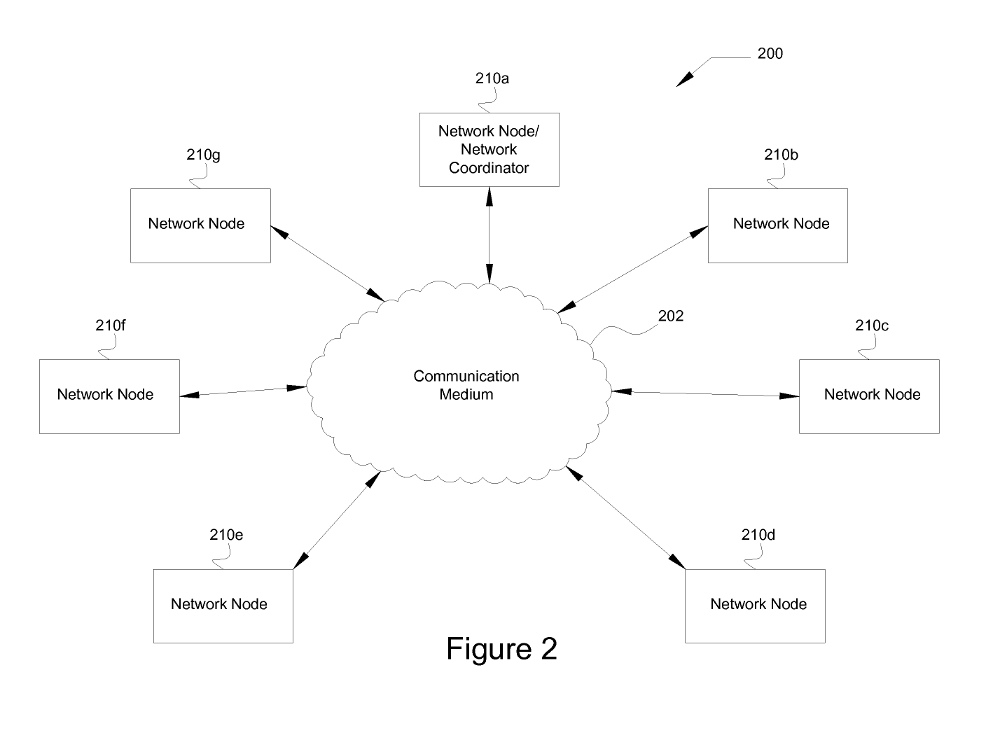

FIG. 2 illustrates one example of a communication system 200 (network 200) including a plurality of network nodes 210a-g (collectively referred to as “network nodes 210”) each configured to communicate with other nodes through a communication medium 202, which may be channel 202. Examples of the communication medium 202 include, but are not limited to, coaxial cable, fiber optic cable, a wireless transmission medium, an Ethernet connection, or the like. It is understood by those known in the art that the term “network medium” is the same as “communication medium.” In one embodiment, communication medium 202 is a coaxial cable network.

Network nodes 210 may be devices of a home entertainment system such as, for example, set top boxes (STBs), televisions (TVs), computers, Digital Versatile Disc (DVD) or Blu-ray players/recorders, gaming consoles, or the like, coupled to each other via communication medium 202. Various embodiments may be implemented on or using any such network node 210.

In some embodiments, communication system 200 may be a Multimedia over Coax Alliance network. The MoCA architecture dynamically assigns a network node 210 as a network controller/network coordinator (NC) in order to optimize performance. Any network node 210 may be the NC, as is understood by one of ordinary skill in the art; for the sake of this example, assume network node 210a is an NC. Only a device in the NC 210a role is able to schedule traffic for all other nodes 210b-g in the network and form a full mesh network architecture between any device and its peers.

Embodiments of the present disclosure may be implemented in a MoCA network but are not limited to MoCA, which is a particular industry standard protocol. Rather, embodiments are applicable in a variety of access contexts.

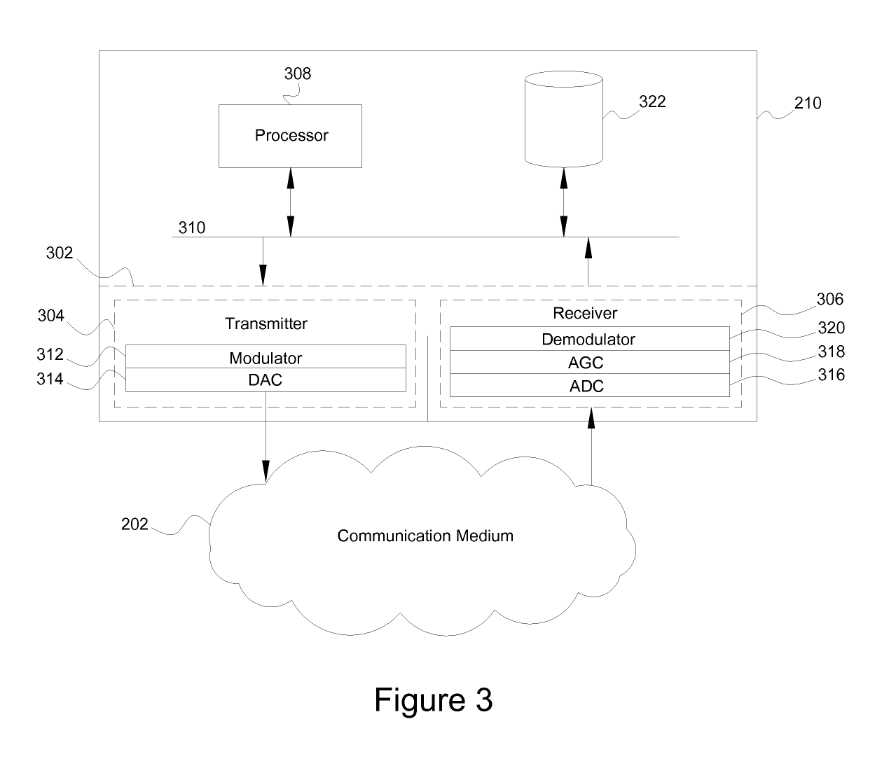

Referring to FIG. 3, each of the network nodes 210 may include a physical interface 302 including a transmitter 304 and a receiver 306, which are in signal communication with a processor 308 through a data bus 310. The transmitter 304 may include a modulator 312 for modulating data according to a quadrature amplitude modulation (QAM) scheme, e.g., 8-QAM, 16-QAM, 32-QAM, 64-QAM, 128-QAM, or 256-QAM, or another modulation scheme. The transmitter 304 may also include a digital-to-analog converter (DAC) 314 for transmitting modulated signals to other network nodes 300 through the communication medium 202.

Receiver 306 may include an analog-to-digital converter (ADC) 316 for converting an analog modulated signal received from another network node 210 into a digital signal. Receiver 306 may also include an automatic gain control (AGC) circuit 318 for adjusting the gain of the receiver 306 to properly receive the incoming signal and a demodulator 320 for demodulating the received signal. One of ordinary skill in the art will understand that the network nodes 210 may include additional circuitry and functional elements not described herein.

Processor 308 may be any central processing unit (CPU), microprocessor, micro-controller, or computational device or circuit for executing instructions. As shown in FIG. 3, the processor 308 is in signal communication with a computer readable storage medium 322 through data bus 310. The computer readable storage medium may include a random access memory (RAM) and/or a more persistent memory such as a read only memory (ROM). Examples of RAM include, but are not limited to, static random-access memory (SRAM), or dynamic random-access memory (DRAM). A ROM may be implemented as a programmable read-only memory (PROM), an erasable programmable read-only memory (EPROM), an electrically erasable programmable read-only memory (EEPROM), or the like as will be understood by one skilled in the art.

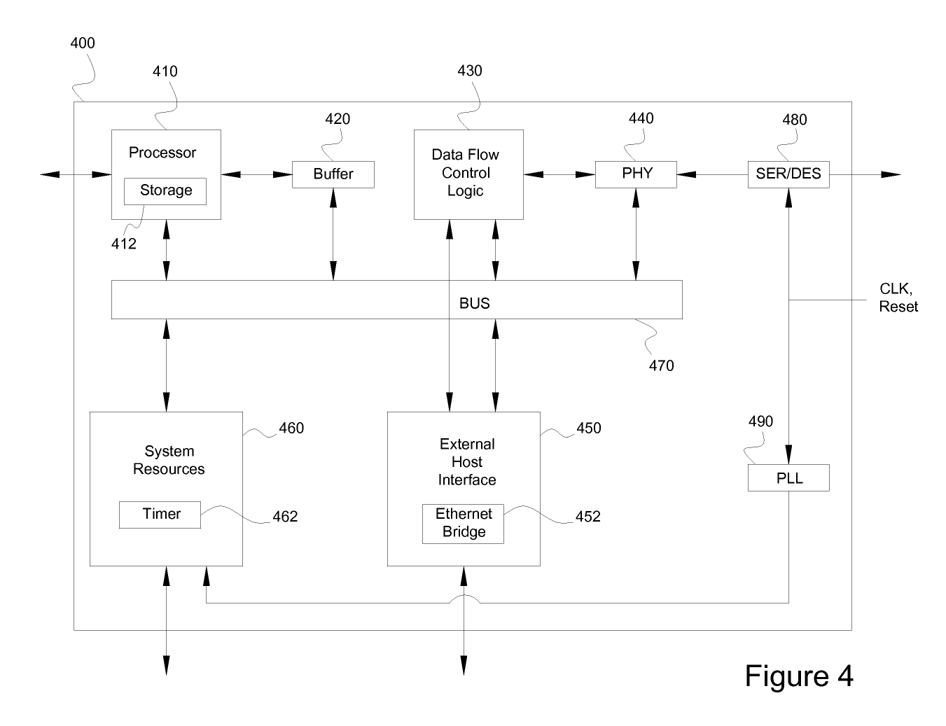

FIG. 4 is a block diagram of a hardware chip-level implementation of a network node in accordance with the communication system illustrated in FIG. 2. FIG. 4 shows various components that may be included on a chip to implement functionality corresponding to a network node, which may be a network coodinator (NC) node or another node. A NC node may include similar or same hardware as other nodes and may be designated as a NC node dynamically. A processor 410 (which may be processor 308 of FIG. 3), a buffer 420, a data flow control logic 430, a physical interface 440, an external host interface, and a system resource module 460 may be configured to communicate via a system bus 470. The processor 420 may include a storage unit 412, which may be computer readable storage medium 322 of FIG. 3. In some embodiments, the storage unit 412 may be separate from the processor 420. The buffer 420, which may be a shared memory, is coupled to the processor 410 and buffers scheduling instructions that may be received from a NC node to facilitate transmission according to a schedule at the node level. The data flow control logic 430 coupled to the physical interface 440 performs low level control functionality. Transmission from the node occurs at the physical layer represented by physical interface 440. The physical interface may be the physical interface 302 of FIG. 3 and may be used for inter-node communications. An optional host interface may include an Ethernet bridge, e.g., for providing compatibility between Ethernet and MoCA. The system resources 460 includes a timer 462 for triggering transmission at scheduled times. A clock signal and a reset signal may be provided to a serializer/deserializer 480, converts between serial and parallel data, and to a phase locked loop 490, which may provide a baseband clock to the system resource module 460.

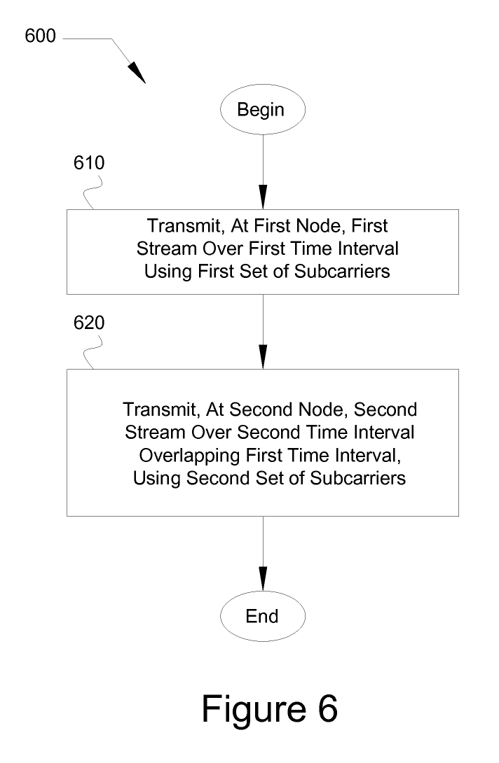

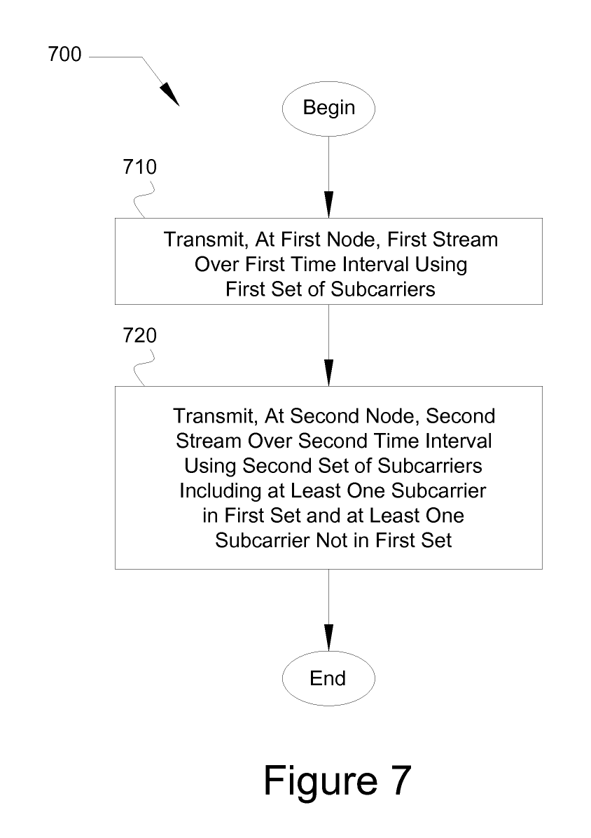

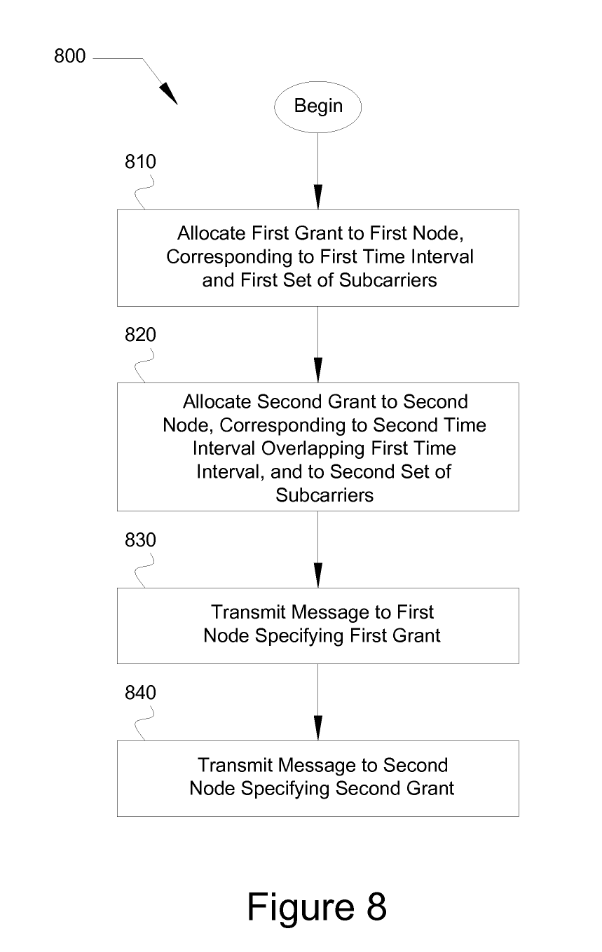

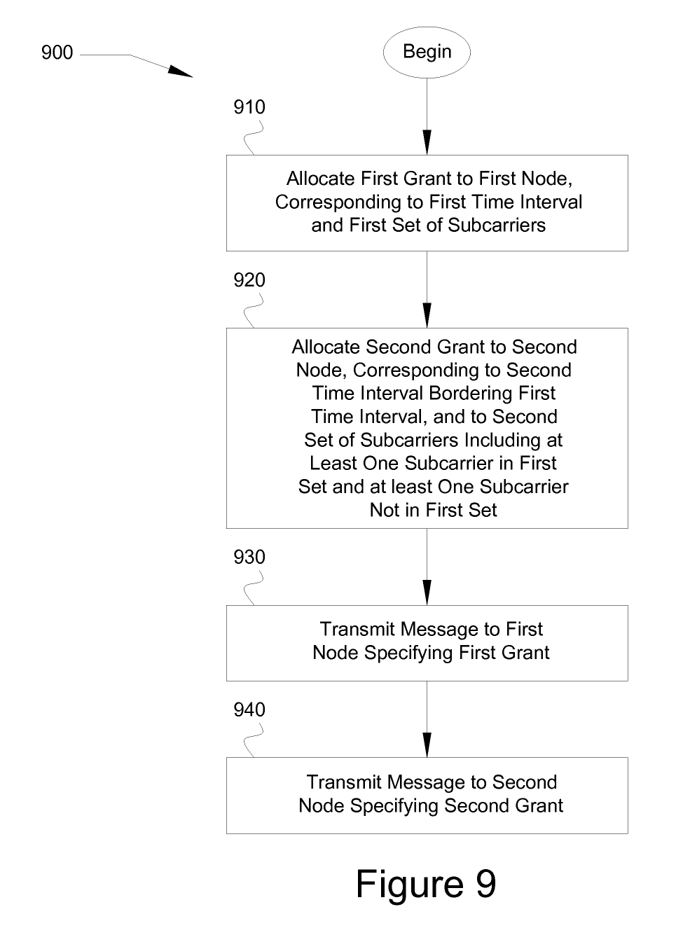

The chip architecture shown in FIG. 4 may be used to implement various embodiments; other architectures may be used as well. Nodes may correspond to various types of devices on a network (e.g., a MoCA network or any broadband network like network 150 having a network coordinator node), including set top boxes, televisions, DVD or Blu-ray players or recorders, gaming consoles, computers (e.g., personal computers, desktop computers, notebook computers, handheld computers, or smart phones), and other devices with suitable hardware for communication on a network and processing instructions. Each network node 210 may be implemented using a separate chip 400. In some embodiments, a node designated as the network coordinator (NC) node determines a schedule for allotting subcarriers or subchannels to various network nodes (each having a transmitter) in a multiple access context with greater flexibility and efficiency than is available in the prior art. The NC node distributes pertinent schedule information to respective nodes, e.g., using broadcast messages (in which case schedule information for all nodes may be sent to each node) or unicast messages (in which case node-specific schedule information may be sent). Schedule information may be sent via media access plan (MAP) messages. Within each chip 400 corresponding to a particular node, the processor 410 functions to implement the transmission schedule for that node. Instructions stored tangibly in storage 412 may cause the processor 410 to effectuate transmission at the physical interface 440 in accordance with processes 600 and 700 described below in the context of FIGS. 6-7 for recipient nodes and in in accordance with processes 800 and 900 described below in the context of FIGS. 8-9 for a NC node. Schedule instructions received at a recipient node from the NC node may be stored in buffer 420. Based on the timer 462 and the schedule received from the NC node, the processor of a recipient node may cause the transmitter (represented by physical interface 440 in FIG. 4; transmitter details are shown in FIG. 3) to initiate a data burst (data stream).

In accordance with some embodiments, an asynchronous orthogonal frequency division multiple access scheme is used in which a NC schedules nodes to start their OFDMA transmissions at the next symbol boundary without waiting for other nodes to finish. For example, this allows, one node to transmit its preamble while another node is transmitting its payload (and vice versa), without requiring time alignment of the start of each preamble. Since each node uses a different set (subchannel) of subcarriers, the NC node can distinguish between communications associated with different nodes.

Therefore, in accordance with some embodiments, transmitting orthogonal frequency division multiple access signals includes transmitting a first stream of data from a first node of a network. In one such embodiment, the first stream includes a preamble and payload.

A second stream of data is also transmitted from a second node of the network. In one such embodiment, the second stream includes a preamble and payload. However, the second stream has a shorter total length than the first stream. That is, the total amount of time necessary to transmit the preamble and the payload is longer for the second stream than for the first stream. Nonetheless, the transmission of the second stream starts at essentially the same time as the transmission of the first stream.

In addition, in accordance with some embodiments, a third stream of data is transmitted from the second node of the network. The third stream also includes a preamble and payload. The transmission of the third stream begins at the end of the payload of the second stream and prior to the end of the transmission of the remainder of the payload of the first stream.

As in synchronous OFDMA, all subcarrier frequencies are preferably harmonically related to maintain orthogonality at the receiver (NC). Nonetheless, the NC node can still perform channel estimation and inverse equalization based on the received preamble symbol(s). The advantages of asynchronous OFDMA include: (1) relaxed constraints on the scheduler at the NC, (2) simplified assignment and distribution of subchannels, and (3) typically less waiting (idle time) on the channel. The tradeoff is that the system may be more complex due to the need to receive and process preambles and payloads simultaneously.

In another embodiment, an OFDMA receiver may not require preamble symbols. In this case, payload transmissions from one node may begin at a symbol boundary that is different from the symbol boundary at which other nodes begin their payload transmissions without the added complexity of receiving and processing preambles and payloads simultaneously. Similarly, payload transmissions from one node may end at a symbol boundary that is different from the symbol boundary at which other nodes end their payload transmissions.

Various embodiments may be used in full-mesh OFDMA networks (multipoint-to-multipoint) in which one or more receivers receive transmissions from one or more other transmitters.

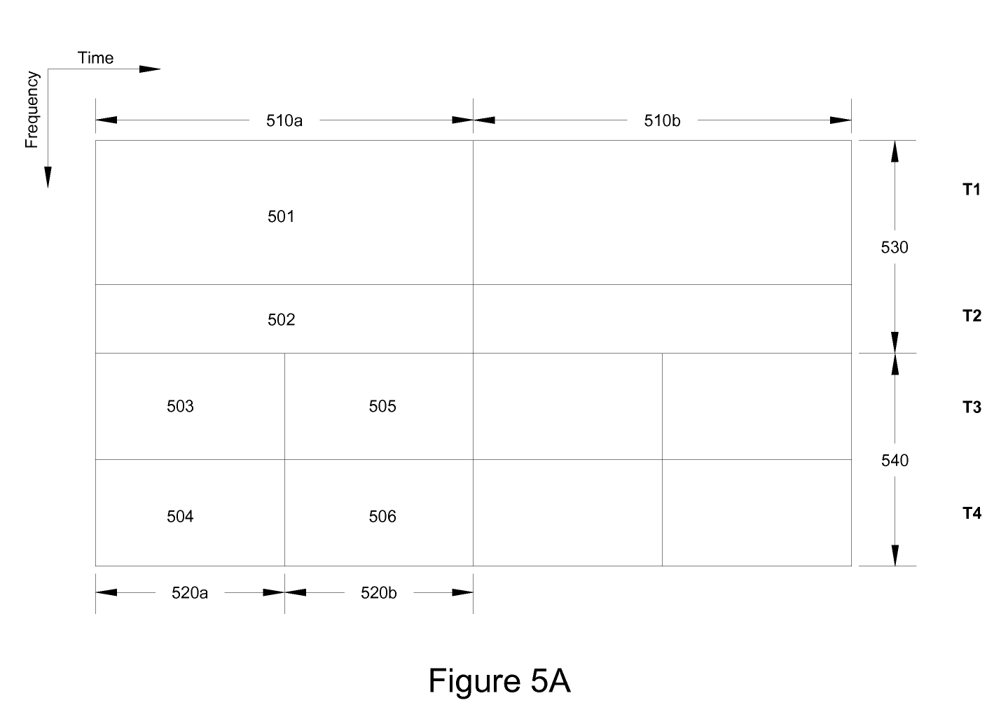

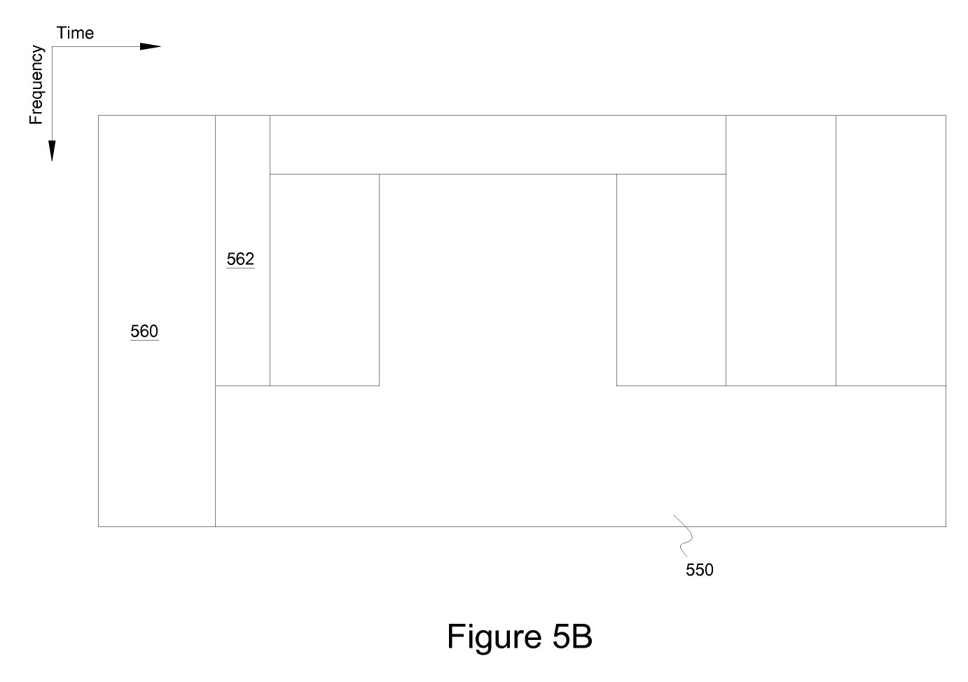

FIGS. 5A-B are illustrations of OFDMA transmission in accordance with some embodiments. FIG. 5A shows allotment of frequency over time (i.e., allotment in time-frequency space) for transmitters T1, T2, T3, and T4. The transmitters may be allotted (granted) subchannels occupying different amounts of bandwidth. One or more subchannels may be assigned to each transmitter, with each subchannel comprising a set of one or more subcarriers that are adjacent in frequency or distributed (non-adjacent) in frequency. Adjacent subcarriers are associated with better channel coherence within subchannels, and distributed subcarriers are associated with better frequency diversity within subchannels. A mapping of subcarriers to subchannels may be predetermined at a head-end node and pre-distributed to various nodes via a downstream broadcast.

During time interval 510a, transmitters T1 and T2 are assigned grants 501 and 502, respectively. Rather than requiring transmitter T3 to adhere to the same timing allotment as transmitters T1 and T2, embodiments allow T3 to transmit bursts in grants 503 and 505 having respective intervals 520a and 520b that are shorter than interval 510a. Similarly, T4 transmits bursts in grants 504 and 506 having time intervals 520a and 520b, respectively.

Embodiments provide increased flexibility and efficiency by transmitter T3 to begin a new burst in grant 505 before a burst in grant 502 has completed (e.g., before transmission of the entirety of the payload of a packet transmitted in grant 502). Providing a hybrid allotment capability ensures that advantageous characteristics of both long and short time allotments may be realized in the context of varying service needs and network conditions. Providing relatively long-duration grants (e.g., grants 501 and 502 in FIG. 5A) typically offers the advantage of low overhead at the cost of high latency. Additionally, because a given amount of data transmitted over a longer interval (e.g., with more symbols) requires less bandwidth, increasing the burst time duration typically increases the number of transmitters needed. For the same given amount of data to be transmitted in a multiple access context, reducing burst length reduces latency and the number of transmitters needed but increases overhead (because more grants need to be scheduled, accounted for, and executed).

To make clear the latency reduction when decreasing the time duration of grants, consider the following example. Suppose fixed bursts of length 20 symbols are used, and suppose bursts in grants 501 and 502 are two such 20-symbol bursts. Then the physical layer (PHY) buffering latency (i.e., the time from when a report is received to the next schedulable transmission opportunity, or the time the scheduler must wait for the PHY in other words) is on average half of 20 symbols, i.e., 10 symbols. If the burst length is halved (and the burst frequency width is doubled) to 10 symbols, then PHY buffering latency will be 5 symbols, for an improvement of 5 symbols. In addition to the PHY buffering latency reduction, a PHY transmission duration latency reduction of 10 symbols is observed when reducing the burst length from 20 to 10 symbols. Then, the total PHY latency reduction is 5+10=15 symbols.

Thus, each regime (relatively long or short bursts) has its advantages and disadvantages. Formerly, multiple access implementations have been constrained to one regime or the other. Various embodiments allow the benefits of either regime to be enjoyed as shown in FIG. 5A. In some embodiments, certain frequency ranges may be reserved for certain traffic classes. For example, frequency interval 530 may be reserved for residential access (e.g., consumer modems), and frequency interval 540 may be reserved for commercial service level agreements (SLAs). Long and short bursts may also be assigned for a given user based on different data characteristics and requirements, e.g., email (tolerant of high latency) and video (demanding low latency). Scheduling OFDMA transmissions asynchronously as in various embodiments, with flexible transmission start times, enables various objectives to be met in changing circumstances.

Asynchronous OFDMA also includes dynamic scheduling and allocation of time-frequency bursts in some embodiments. As shown in FIG. 5B, various types of grants (having various time durations and frequency extents) may be scheduled and executed, e.g., based on real-time network and traffic conditions. Time-frequency grants may be configured in various ways and with time-frequency tiles of various shapes and sizes (hetereogeneous tiling). In its simplest form, a tile represents the usage by a transmitter of one or more subcarriers at various times corresponding to symbol slots. Thus, tiles may start and end (in the time dimension) at symbol boundaries. Some tiles may be conceptualized as rectangular in the sense of a uniform allotment of logical subchannels over a given time interval, with the understanding that subchannels may comprise distributed (non-adjacent) subcarriers, so a tile need not comprise a topologically connected region in time-frequency space. In the example of FIG. 5B, nonrectangular tile 550 may be decomposed into multiple rectangular tiles. As opposed to homogeneous tiling dictated by conventional synchronous OFDMA techniques, asynchronous OFMDA in accordance with various embodiments allows transmitters to be allotted as many or as few subcarriers as appropriate, and for differing lengths of time.

Heterogeneity in the time duration of tiles was discussed above in the context of FIG. 5A. FIG. 5B illustrates heterogeneity in frequency as well, with tiles 560 and 562 having different frequency characteristics and not conforming to a periodic time-frequency grid as in prior art approaches. Tile 560 includes at least one subcarrier not included in tile 562. By providing heterogeneity in time and frequency, embodiments facilitate the scheduling of a given amount of data in various ways. For example, if latency is at a premium or the network is not congested, additional subchannels may be included in a grant, and if bandwidth is scarce, fewer subchannels may be used in conjunction with a longer time interval. Because tiling is not constrained to a rectangular grid that is periodic in time and frequency, various scheduling methodologies may be used. For example, a scheduler at a network coordinator (NC) may optimally place low-latency bursts and then schedule latency-tolerant bursts to efficiently fill in any remaining gaps in time-frequency space with tiles that are appropriately dimensioned.

FIG. 6 is a flow diagram in accordance with some embodiments. After process 600 begins, at a first network node of a network (e.g., at a transmitter at the first network node), a first stream of data having a first number of symbols is transmitted (610) over a first time interval using a first set of one or more Orthogonal Frequency Division Multiple Access subcarriers. At a second network node of the network (e.g., at a transmitter at the second network node), a second stream of data is transmitted (620) having a second number of symbols over a second time interval, different in duration than the first time interval and overlapping the first time interval. The second burst of data is transmitted using a second set of one or more OFDMA subcarriers. The first time interval and first set of subcarriers define a first time-frequency grant, the second time interval and second set of subcarriers define a second time-frequency grant, and the first and second time-frequency grants are granted by a network coordinator node of the network. The first and second time intervals may have different start times, end times, or both. At the second network node, a third stream of data may be transmitted beginning at a symbol boundary succeeding the end of the second time interval. The end of the first time interval may be after the end of the second time interval, and the symbol boundary may be before the end of the first time interval. Thus, a data stream can begin transmission at a next symbol boundary without having to wait for other nodes to finish transmission of their respective streams as in conventional OFDMA approaches.

FIG. 7 is a flow diagram in accordance with some embodiments. After process 700 begins, at a first network node of a network (e.g., at a transmitter at the first network node), a first stream of data is transmitted (710) over a first time interval using a first set of one or more OFDMA subcarriers. At a second network node of the network (e.g., at a transmitter at the second network node), a second stream of data is transmitted (720) over a second time interval using a second set of one or more OFDMA subcarriers. The second set includes at least one subcarrier in the first set and at least one subcarrier not in the first set. The first time interval and first set of subcarriers define a first time-frequency grant, the second time interval and second set of subcarriers define a second time-frequency grant, and the first and second time-frequency grants are granted by a network coordinator node of the network. The first network node may be the same as the second network node, and the first and second time intervals may border one another, in which case a single transmitter transmits in adjacent time intervals using different frequency allotments.

Various combinations of overlapping time intervals and overlapping frequency subcarriers may be used, following the disclosure above regarding processes 600 and 700, to achieve heterogeneous tiling in the time-frequency space.

FIG. 8 is a flow diagram in accordance with some embodiments. After process 800 begins, a first time-frequency grant is allocated (810) to a first network node of the network. The first time-frequency grant corresponds to a first time interval and a first set of one or more orthogonal frequency division multiple access subcarriers. A second time-frequency grant is allocated (820) to a second network node of the network. The second time-frequency grant corresponds to a second time interval, different in duration than the first time interval and overlapping the first time interval, and to a second set of one or more OFDMA subcarriers. A first message is transmitted (830) to the first network node specifying the first time-frequency grant, and a second message is transmitted (840) to the second network node specifying the second time-frequency grant.

FIG. 9 is a flow diagram in accordance with some embodiments. After process 900 begins, a first time-frequency grant is allocated (910) to a first network node of the network. The first time-frequency grant corresponds to a first time interval and a first set of one or more orthogonal frequency division multiple access subcarriers. A second time-frequency grant is allocated (920) to a second network node of the network. The second time-frequency grant corresponds to a second time interval, bordering the first time interval, and to a second set of one or more OFDMA subcarriers including at least one subcarrier in the first set and at least one subcarrier not in the first set. A first message is transmitted (930) to the first network node specifying the first time-frequency grant, and a second message is transmitted (940) to the second network node specifying the second time-frequency grant.

While various embodiments of the disclosed method and apparatus have been described above, it should be understood that they have been presented by way of example only, and should not limit the claimed invention. The claimed invention is not restricted to the particular example architectures or configurations disclosed. Rather, the desired features can be implemented using a variety of alternative architectures and configurations. Indeed, it will be apparent to one of skill in the art how alternative functional, logical or physical partitioning and configurations can be implemented to implement the desired features of the disclosed method and apparatus. Thus, the breadth and scope of the claimed invention should not be limited by any of the above-described exemplary embodiments.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide examples of instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

A group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should also be read as “and/or” unless expressly stated otherwise. Furthermore, although items, elements or components of the disclosed method and apparatus may be described or claimed in the singular, the plural is contemplated to be within the scope thereof unless limitation to the singular is explicitly stated.

What is claimed is:

1. A method of transmitting orthogonal frequency division multiple access signals, the method comprising:
transmitting, at a first network node of a network, a first stream of data having a first number of symbols over a first time interval using a first set of one or more orthogonal frequency division multiple access (OFDMA) subcarriers; and
transmitting, at a second network node of the network, a second stream of data having a second number of symbols over a second time interval different in duration than the first time interval and overlapping the first time interval, using a second set of one or more OFDMA subcarriers;
wherein the first time interval and first set of subcarriers define a first time-frequency grant, the second time interval and second set of subcarriers define a second time-frequency grant, and the first and second time-frequency grants are granted by a network coordinator node of the network.

2. The method of claim 1 wherein the first and second time intervals begin at different times.

3. The method of claim 1 wherein the first and second time intervals end at different times.

4. The method of claim 1 wherein the first and second sets of subcarriers are reserved for data of first and second traffic classes, respectively.

5. The method of claim 4 wherein the first traffic class is residential traffic, and the second traffic class is commercial service level agreement (SLA) traffic.

6. The method of claim 1, further including transmitting, at the second network node, a third stream of data beginning at a symbol boundary succeeding the end of the second time interval;
wherein the end of the first time interval is after the end of the second time interval, and the symbol boundary is before the end of the first time interval.

7. The method of claim 6, wherein the first and second time intervals begin at the same time.

8. A method of transmitting orthogonal frequency division multiple access signals, the method comprising:
transmitting, at a first network node of a network, a first stream of data over a first time interval using a first set of one or more orthogonal frequency division multiple access (OFDMA) subcarriers; and
transmitting, at a second network node of the network, a second stream of data over a second time interval using a second set of one or more OFDMA subcarriers including at least one subcarrier in the first set and at least one subcarrier not in the first set;
wherein the first time interval and first set of subcarriers define a first time-frequency grant, the second time interval and second set of subcarriers define a second time-frequency grant, and the first and second time-frequency grants are granted by a network coordinator node of the network.

9. The method of claim 8 wherein the first network node is the second network node.

10. The method of claim 9 wherein the first time interval borders the second time interval.

11. A method of scheduling transmission of orthogonal frequency division multiple access signals, the method performed at a network coordinator node of a network, the method comprising:
allocating a first time-frequency grant to a first network node of the network, the first time-frequency grant corresponding to a first time interval and a first set of one or more orthogonal frequency division multiple access (OFDMA) subcarriers;
allocating a second time-frequency grant to a second network node of the network, the second time-frequency grant corresponding to a second time interval, different in duration than the first time interval and overlapping the first time interval, and a second set of one or more OFDMA subcarriers;
transmitting a first message to the first network node specifying the first time-frequency grant; and
transmitting a second message to the second network node specifying the second time-frequency grant.

12. A method of scheduling transmission of orthogonal frequency division multiple access signals, the method comprising:
allocating a first time-frequency grant to a first network node of the network, the first time-frequency grant corresponding to a first time interval and a first set of one or more orthogonal frequency division multiple access (OFDMA) subcarriers;
allocating a second time-frequency grant to a second network node of the network, the second time-frequency grant corresponding to a second time interval, bordering the first time interval, and a second set of one or more OFDMA subcarriers including at least one subcarrier in the first set and at least one subcarrier not in the first set;
transmitting a first message to the first network node specifying the first time-frequency grant; and
transmitting a second message to the second network node specifying the second time-frequency grant.

13. An apparatus forming a network node on a network, said apparatus comprising:
a computer processor;
a physical layer interface including a transmitter and a receiver, said physical layer interface configured to provide communication between said apparatus and at least one other network node on the network, said at least one other network node including a network coordinator (NC) node;
a buffer coupled to said processor, said buffer configured to store schedule orders received from said NC node;
a timer;
a bus configured to provide communication between said processor, said physical layer interface, said buffer, and said timer;
a computer readable storage medium having computer-executable instructions stored tangibly thereon, said instructions when executed causing said processor to transmit, at a time based on the stored schedule orders and the timer, a first stream of data having a first number of symbols over a first time interval using a first set of one or more orthogonal frequency division multiple access (OFDMA) subcarriers;
wherein the first burst of data has a different number of symbols than a second burst of data that is transmitted at one of the other network nodes over a second time interval different in duration than the first time interval and overlapping the first time interval, using a second set of one or more OFDMA subcarriers.

14. The apparatus of claim 13 wherein the first and second time intervals begin at different times.

15. The apparatus of claim 13 wherein the first and second time intervals end at different times.

16. The apparatus of claim 13 implemented in a set top box configured to communicate over the network.

17. The apparatus of claim 13 implemented in a television configured to communicate over the network.

18. The apparatus of claim 13 implemented in a DVD or Blu-ray player or recorder.

19. The apparatus of claim 13 implemented in a gaming console.

20. The apparatus of claim 13 implemented in a computer configured to communicate over the network.

21. The apparatus of claim 13, wherein the network is a Multimedia over Coax Alliance (MoCA) network.

22. An apparatus forming a network node on a network, said apparatus comprising:
a computer processor;
a physical layer interface including a transmitter and a receiver, said physical layer interface configured to provide communication between said apparatus and at least one other network node on the network, said at least one other network node including a network coordinator (NC) node;
a buffer coupled to said processor, said buffer configured to store schedule orders received from said NC node;
a timer;
a bus configured to provide communication between said processor, said physical layer interface, said buffer, and said timer;
a computer readable storage medium having computer-executable instructions stored tangibly thereon, said instructions when executed causing said processor to transmit, at a time based on the stored schedule orders and the timer, a first stream of data over a first time interval using a first set of one or more orthogonal frequency division multiple access (OFDMA) subcarriers;
wherein at least one subcarrier in the first set is in a second set of one or more OFDMA subcarriers used for transmitting a second stream of data at a second network node of the network over a second time interval, and at least one subcarrier in the first set is not in the second set.

23. The apparatus of claim 22, wherein the first network node is the second network node.

24. The apparatus of claim 23 wherein the first time interval borders the second time interval.

25. An apparatus forming a network coordinator (NC) node on a network, said apparatus comprising:
a computer processor;
a physical layer interface including a transmitter and a receiver, said physical layer interface configured to provide communication between the NC node, a first recipient network node on the network, and a second recipient network node on the network;
a bus configured to provide communication between said processor and said physical layer interface;
a computer readable storage medium having computer-executable instructions stored tangibly thereon, said instructions when executed causing said processor to:
transmit a first message to the first recipient network node, the first message allocating to the first recipient node a first time-frequency grant corresponding to a first time interval and a first set of one or more orthogonal frequency division multiple access (OFDMA) subcarriers;
transmit a second message to the second recipient node, the second message allocating to the second recipient node a second time-frequency grant corresponding to a second time interval, different in duration than the first time interval and overlapping the first time interval, and a second set of one or more OFDMA subcarriers;
wherein the NC node is configured to coordinate asynchronous transmissions for upstream reservation requests of the first and second recipient network nodes received at the receiver.

26. An apparatus forming a network coordinator (NC) node on a network, said apparatus comprising:
a computer processor;
a physical layer interface including a transmitter and a receiver, said physical layer interface configured to provide communication between the NC node, a first recipient network node on the network, and a second recipient network node on the network;
a bus configured to provide communication between said processor and said physical layer interface;
a computer readable storage medium having computer-executable instructions stored tangibly thereon, said instructions when executed causing said processor to:
transmit a first message to the first recipient network node, the first message allocating to the first recipient node a first time-frequency grant corresponding to a first time interval and a first set of one or more orthogonal frequency division multiple access (OFDMA) subcarriers;
transmit a second message to the second recipient node, the second message allocating to the second recipient node a second time-frequency grant corresponding to a second time interval, bordering the first time interval, and a second set of one or more OFDMA subcarriers including at least one subcarrier in the first set and at least one subcarrier not in the first set;
wherein the NC node is configured to coordinate asynchronous transmissions for upstream reservation requests of the first and second recipient network nodes received at the receiver.
